(19) United States
(12) Patent Application Publication
(10) Pub. No.: US 2012/0080970 A1
(43) Pub. Date: Apr. 5, 2012

(54) HIGH VOLTAGE AND HIGH TEMPERATURE WINDING INSULATION FOR ESP MOTOR

(75) Inventors: Weijun YIN, Niskayuna, NY (US); Sergei KNIAJANSKI, Clifton Park, NY (US); James Jun XU, Niskayuna, NY (US); Patricia Chapman IRWIN, Altamont, NY (US)

(73) Assignee: GENERAL ELECTRIC COMPANY, Schenectady, NY (US)

(21) Appl. No.: 13/323,259

(22) Filed: Dec. 12, 2011

Related U.S. Application Data
(63) Continuation-in-part of application No. 12/709,560, filed on Feb. 22, 2010.
Application No. 12/709,560 is a continuation-in-part of application No. 12/968,437, filed on Dec. 15, 2010.

(51) Int. Cl. H02K 5/132; H02K 3/30; H01B 7/29; B82Y 30/00

(52) U.S. Cl. 310/87; 174/120 C; 310/179; 977/773

(57) ABSTRACT

A litz wire includes, in one embodiment, a plurality of twisted strands, wherein one or more of the strands includes a composite magnet wire. The composite magnet wire includes a metal wire having a nanocoating on its outer surface. The nanocoating includes an electrical insulating polyimide matrix and a plurality of alumina nano particles dispersed homegenueoslytherein. The alumina nano particles have a phenyl siloxane surface coating. The litz wire has a temperature index of at least 300° C. as obtained in accordance with either ASTM E1641, ASTM E1877, or ASTM D2307. Motors and ESP assemblies utilizing the litz wire are also disclosed.

### CROSS REFERENCE TO RELATED APPLICATIONS

This application is a continuation-in-part of U.S. application Ser. No. 12/709,560, filed on Feb. 22, 2010, which published as U.S. 2011-0207863 on Aug. 25, 2011, and of U.S. application Ser. No. 12/968,437, filed on Dec. 15, 2010. Both of the prior applications are hereby incorporated herein by reference.

### BACKGROUND

The field of the invention relates generally to high temperature high frequency magnet wire, and more particularly to a litz wire comprising a composite magnet wire having an electrical insulating nanocoating that includes alumina nano particles homogeneously dispersed in a polyimide polymer, and to motors comprising the same, for example, electrical submersible pump motors.

Coated electrical conductors typically include one or more electrical insulation layers, also referred to as wire enamel compositions, formed around a conductive core. Magnet wire is one form of coated electrical conductor in which the conductive core is a copper wire or copper alloy, and the insulation layer or layers include dielectric materials, such as those high temperature and high voltage endurance polymeric resins, coated peripherally around the conductor. Magnet wire is used in the electromagnet windings of transformers, electric motors, and the like. Because of its use in such windings, the insulation system of magnet wire must be sufficiently flexible such that the insulation does not delaminate or crack or otherwise suffer damage during winding operations and in service. The insulation system must also be sufficiently abrasion resistant so that the outer surface of the system can survive the friction, scraping, and abrading forces that can be encountered during winding operations. The insulation system also must be sufficiently durable and resistive to degradation so that dielectric properties are maintained over a long period of time.

Magnet wire is also used in the construction of transformers, inductors, motors, headphones, loudspeakers, hard drive head positioners, potentiometers, and electromagnets, among other applications. Magnet wire is the primary insulation used in electric machines, motors, generators and transformers as winding coils. The magnet wire carries alternating current and generates an electromagnetic field and induced electric power. Magnet wire typically uses multiple layers of polymer insulation to provide a tough, continuous insulating layer. Magnet wire insulating coatings may be, for example, in order of increasing temperature range, polyurethane, polyamide, polyester, polyester-polyimide, polyamide-polyimide, and polyimide. Prior art polyimide insulated magnet wire is generally capable of operation at up to 250° C.

Electrical submersible pump (ESP) systems are used in a wide variety of environments, including wellbore applications and well fluid lifting in an enhanced geothermal system for pumping production fluids such as water or petroleum. The submersible pump system includes, among other components, an induction or a permanent magnet motor used to power a pump, lifting the production fluids to the surface. Further, a power cable including a conductor and an insulating layer typically extends downhole to power the electric motor.

In certain applications, for example, down-hole ESP systems for drilling in oil and gas industries, it may be desirable to operate the ESP motor at high temperatures (for example, greater than 300° C.). However, high temperatures may lead to undesirable degradation of the electrical insulation used in the electric cables for ESP motors. Typically, the insulating layers used in electric cables for ESP motors include organic insulation materials such as polymer-based insulations that are configured to operate at low temperatures. The dielectric properties of these polymeric insulations tend to degrade over time at high temperatures.

Thus, there is a need for improved insulated electric cables that allow for continuous operation of motors, including ESP motors, in high temperature environments for extended periods of time.

### BRIEF DESCRIPTION OF THE INVENTION

In one aspect, a litz wire is provided. The litz wire includes a plurality of twisted strands. One or more of the strands includes a composite magnet wire which includes a metal wire coated with a coating comprising a polyimide polymer and a plurality of alumina nano particles homogeneously dispersed therein. The alumina nano particles have a phenyl siloxane surface coating which only not enhances bonding between nano particulate matter and polyimide matrix, but also promotes its effective homogeneous dispersion, as nanoparticles may agglomerate The composite magnet wire has a temperature index (or thermal index) of at least 300° C. as calculated in accordance with ASTM E1641, ASTM E1877, or ASTM D2307 (2005).

In another aspect, a motor is provided. The motor includes a hermetically sealed casing containing an oil-filled space and at least one spool of litz wire disposed within the oil-filled space of the casing.

In another aspect, an electrical submersible pump assembly is provided. The electrical submersible pump assembly includes a pump, a motor configured to operate the pump, and an electrical cable connected to the motor to electrically power the motor. The motor includes a hermetically sealed casing containing an oil-filled space, and at least one spool of litz wire disposed within the oil-filled space of the casing.

### BRIEF DESCRIPTION OF THE DRAWINGS

FIG. 1 is a cross-sectional view of one embodiment of a litz wire.

FIG. 2 is an enlarged schematic sectional end view of one embodiment of a composite magnet wire strand.

FIG. 3 is a side view of an electrical submersible pump assembly disposed within a wellbore in accordance with one embodiment of the invention.

FIG. 4A is a side view of a motor in accordance with one embodiment of the invention.

FIG. 4B is a side view of a motor in accordance with one embodiment of the invention.

### DETAILED DESCRIPTION OF THE INVENTION

A litz wire comprising a composite magnet wire is described below in detail, as are motors and electrical submersible pump (ESP) assemblies comprising the litz wire. The litz wire may be used in various other electric machines, for example, generators, transformers, inductors, and the like.

Litz wire (from the German litzendraht, braided wire), also known as bunched wire, is a type of cable that may be used to mitigate the skin effect for current with relatively high frequencies, such as a few kilohertz, a few megahertz, or more. The skin effect is the tendency of an AC electric current to distribute itself within a conductor such that the current density (i.e., current per cross-sectional area) near the surface of the conductor is greater than at its core. In other words, the current tends to flow at the “skin” of the conductor. The skin effect is due to eddy currents formed by the AC current. Litz wire may be used in the windings of various electric machines, e.g., high-frequency transformers, to increase their efficiency by mitigating both skin effect and another phenomenon referred to as proximity effect, which is caused by an interaction of magnetic fields between multiple conductors. According to some embodiments of the present disclosure, any weaving or twisting pattern of litz wire may be selected so that individual wires will reside for short intervals on the outside of cable and for short intervals on the inside of the cable, which may allow the interior of the litz wire to contribute to the cable's conductivity.

The litz wire of the present disclosure comprises one or more strands comprising a composite magnet wire. A polyimide coating is applied to the magnet wire for electrical insulation properties. Alumina nano particles are dispersed in the polyimide coating. Alumina is also known as aluminum oxide (Al₂O₃). The alumina nano particles include a surface treatment applied to the outer surface of the alumina nano particles. The surface treatment passivates the surface of the alumina nano particles thereby making the surface nonreactive. Surface passivity prevents the particles from agglomerating and settling in the polyimide coating. It may also enhance the bonding between nano particulate matter and polyimide insulation matrix. Both the litz wire and the coated magnet wire which it comprises exhibit unique properties, including higher thermal capability, as compared to known magnet wire, thereby enabling electric machines to be made with higher power density and to run at high temperature environments. Specifically, the litz wire and the coated magnet wire have a temperature index (or thermal index) of at least 300° C. as calculated in accordance with ASTM E1641 and ASTEM E1877 or ASTM D2307. In contrast, the highest temperature index of known magnet wire is about 250° C. A thermal degradation temperature index of at least about 300° C. permits higher power density in electric machines and permits operation in higher temperature environments and service longevity if operated at below the temperature ratings. In addition, the litz wire exhibits better pulse surge resistance than typically provided in known electric machines which permits increased reliability of inverter driven motors, generators, alternators and other electric machines. While the prior art winding insulation used in ESP motors has a temperature index less than 250° C., the litz provided herein has a temperature index of more than 250° C. (e.g., greater than or equal to 260° C., or, in some embodiments, greater than or equal to 300° C.), and is therefore of particular utility in applications that require high temperature insulation and long service life, for example, ESP motors.

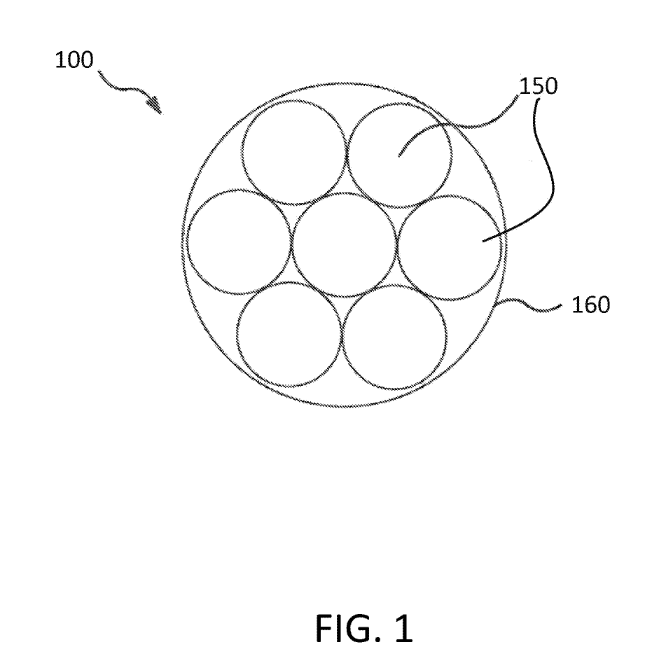

Referring to the drawings, FIG. 1 is a cross-sectional view of a litz wire 100. The litz wire 100 includes a plurality of strands 150 twisted together in a pattern (e.g., a twist, braid, or the like), so that the overall magnetic field acts substantially equally on all the strands and causes the total current to be distributed substantially equally among them. The plurality of strands 150 in the litz wire is covered with a sheath 160. The sheath 160 may provide advantageous properties, for example, additional strength, flexibility, and/or flame resistance. In some embodiments, the sheath 160 may comprise a high temperature resin. In some embodiments, the sheather 160 may for example comprise polytetrafluoroethylene (PTFE), ethylenetetrafluroethylene (ETFE), polyetheretherketone (PEEK), polyamides, siloxanepolyetherimide (SILTEM), glass, thermoplastic polyetherimides such as ULTEM®, polyethersulfone, polyphenylsulfone, polyesters, silicones, polyurethanes, epoxy resins, or blends or alloys of any these. While FIG. 1 illustrates one embodiment of a litz wire, the instant invention encompasses other forms and configurations of litz wires known to those of ordinary skilled in the art. For example, while FIG. 1 illustrates sheath 160 covering one bundle of strands 150 (there being 7 strands in the bundle), there may be fewer or greater strands in the bundle, or sheath 160 may cover more than one bundle of strands 150. Accordingly, the skilled artisan will recognize that litz wires of various suitable weaving and twisting patterns may be used. Litz wires of various configurations amenable for use in the instant disclosure are described, for example, in U.S. Pat. No. 4,546,210, and in U.S. Publication No. 2009/0295531, which are incorporated herein by reference.

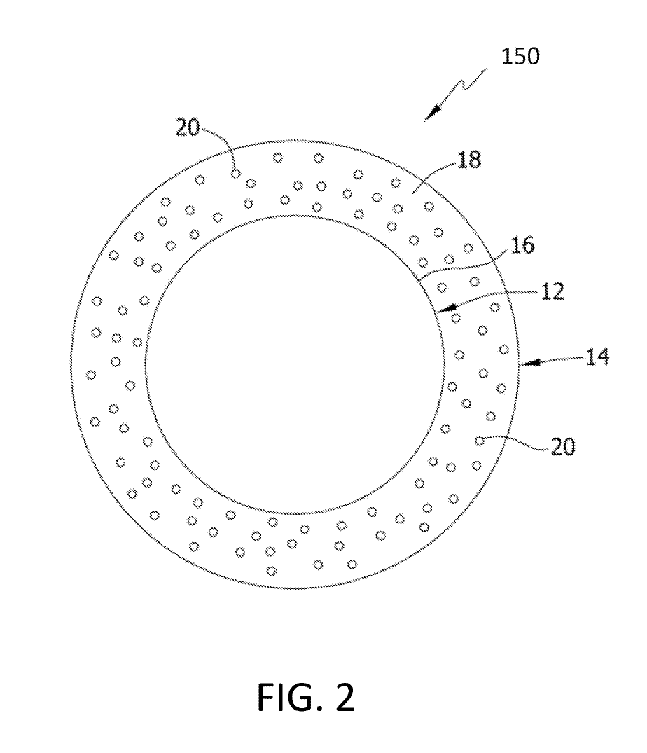

FIG. 2 is a sectional end view schematic of one embodiment of a strand 150 from litz wire 100 as shown in FIG. 1. In the illustrated embodiment of FIG. 2, the strand 150 is a composite magnet wire. At least one strand in litz wire 100 comprises a composite magnet wire. In some embodiments of the present disclosure, litz wire 100 comprises a plurality of composite magnet wires. In some embodiments, each of the strands in litz wire 100 comprises a composite magnet wire. In FIG. 2, composite magnet wire strand 150 includes a conductive core 12 and an insulating coating 14 applied to an outer surface 16 of conductive core 12. Conductive core 12 is generally a metal wire, for example, a copper wire, a copper alloy wire, a silver plated copper wire, a nickel plated or nickel cladded copper wire, an aluminum wire, a copper clad aluminum wire, or the like.

Coating 14 includes an electrical insulating polyimide matrix 18 and a plurality of alumina nano particles 20. Suitable polyimide matrices that may be used include, but are not limited to, those comprising poly(pyromellitic dianhydride-co-4,4′-oxydianiline), amic acid; poly(biphenyltetracarboxylic dianhydride-co-phenylenediamine), amic acid; and mixtures thereof. Poly(pyromellitic dianhydride-co-4,4′-oxydianiline), amic acid is commercially available from Industrial Summit Technology Co., Parlin, N.J., under the trade name of RC5019 Pyre-ML, and poly(biphenyltetracarboxylic dianhydride-co-phenylenediamine), amic acid is commercially available from UBE America, New York, N.Y., under the trade name of UBE-Varnish-S. In some embodiments, coating 14 further comprises a conductor adhesion promoter which may improve the quality of coating 14. For example, in some embodiments, the adhesion promoter may include, e.g., 3,5-diamino-1,2,4-triazole, 1,3,5-triamino triazine, or melamine, or combinations thereof. In some embodiments, coating 14 comprises one coating layer. In other embodiments, coating 14 comprises multiple coating layers, which may increase the thickness of insulating coating 14 to a predetermined thickness. In one embodiment, insulating coating 14 has a thickness of about 38 micrometers (μm) to about 76 μm, in another embodiment, about 45 μm to about 60 μm, and in yet another embodiment, about 25 μm to about 50 μm. Alumina nano particles 20 have an average particle size less than 100 nanometers (nm). In another embodiment, alumina nano particles have an average particle size of about 5 nm to about 50 nm, for example, of about about 20 nm to about 50 nm. The amount of alumina nano particles 20 in coating 14 is about 1% to about 10% by weight in one embodiment, and about 1% to about 6% by weight in another embodiment. The weight percent is based on the total weight of coating 14.

Alumina nano particles 20 have a phenylsiloxane surface coating. The surface coating is a product of treatment of said alumina nano particles 20 with a phenyl-silane. Suitable phenyl-silanes that may be used include, but are not limited to, monofunctional organosilanes disclosed in U.S Publication No. 2011/0207863. In some embodiments, the phenylsiloxane surface coating 14 results from condensation of an aryltrialkoxysilane on the surface of alumina nano particles 20. In some embodiments, the phenyl-silane may be, for example, trimethoxyphenylsilane, triethoxyphenylsilane, and/or mixtures thereof. In one embodiment, to apply the surface treatment to nano particles 20, the particles are suspended in a solvent mixture of anhydrous toluene and an anhydrous alcohol, for example, isopropanol. In one embodiment, the solvent mixture includes a ratio of about 10:1 anhydrous toluene to an anhydrous alcohol. In another embodiment, the solvent mixture includes a ratio of about 10:1 anhydrous toluene to anhydrous isopropanol. The nano particle suspension may be mixed with, for example, a horn sonicator, or any other mixing apparatus. The nano particle suspension is refluxed, in one embodiment, for about 2 to about 4 hours, and in another embodiment, for about 3 hours. The refluxed suspension is cooled to ambient temperature and then filtered to remove the treated nano particles from the solvent mixture. The treated nano particles are then suspended in a polar solvent that is compatible with a polyimide solution prior to its curing. In another embodiment, the refluxed cooled suspension is mixed with an aprotic solvent that is compatible with a polyimide solution and has a boiling point higher than the solvents used for making the suspension. Low boiling solvents (e.g., anhydrous alcohols) are then removed under reduced pressure affording a suspension of the treated nano particles in an aprotic solvent. Suitable aprotic solvents include, but are not limited to, N-methyl-2-pyrrolidone (NMP) and N,N dimethylacetamide (DMA). The suspension of treated nano particles in the aprotic solvent is thoroughly mixed with any suitable mixing equipment, for example, ultrasonic apparatuses and high energy mixers, such as, Cowles mixers.

Wire coating 14 is made by mixing the suspension of treated alumina nano particles 20 with polyimide polymer 18. Any suitable mixing equipment may be used for mixing the suspension of treated alumina nano particles with the polyimide polymer, for example, high energy mixers and ultra sonic apparatuses, such as, horn sonicators. Methods, manufacturing systems, and examples for making the magnet wire strand 150 are disclosed in U.S. application Ser. No. 12/968,437.

Embodiments of the present invention include electric machines comprising the litz wire described herein, including motors and ESP assemblies. In some embodiments, the motors and ESP assemblies may be deployed in a wellbore.

In some embodiments, the litz wire of the present disclosure is configured to power the electric machine, e.g., motor or ESP assembly. The high temperature-withstanding properties of the litz wire allow electric machines to operate in high temperature environments and in applications where the system is exposed to high temperatures (for example, due to system operation) in ambient environments. For example, in some embodiments, electric machines may be exposed to ambient environments yet subjected to high temperatures because the motor is running at high power and high frequency AC current in a continuous fashion. In some embodiments, the litz wire provides dependability in temperature conditions, e.g., in excess of 260° C., for example, in excess of 280° C., or in excess of 290° C., or in excess of 300° C., or in excess of 310° C., or in excess of 320° C., or in excess of 330° C., or in excess of 340° C., or in excess of 350° C.

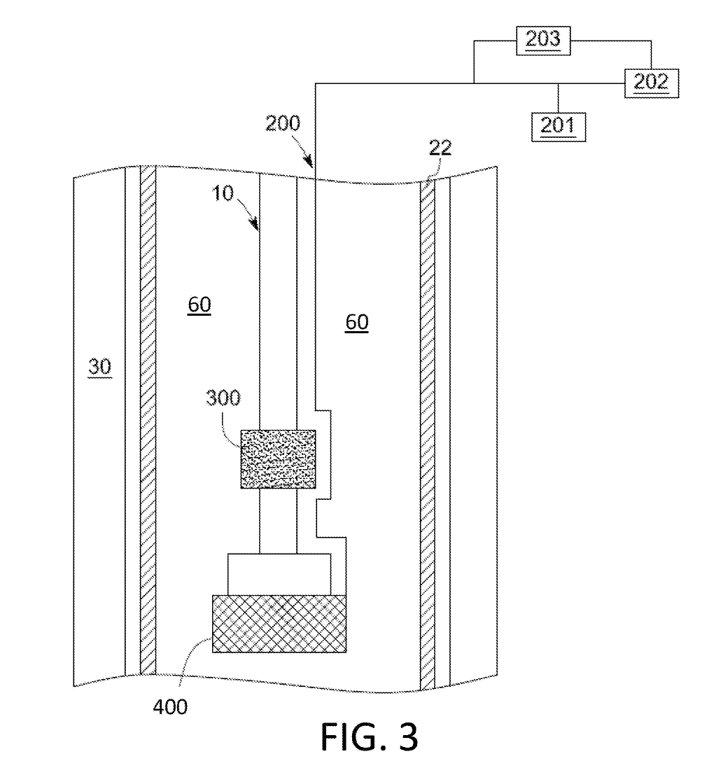

Referring to FIG. 3, one embodiment of an ESP assembly 10 is illustrated wherein the ESP assembly is disposed within a wellbore 60. In one embodiment, the wellbore 60 is formed in a geological formation 30, for example, an oilfield. In some embodiments, the wellbore 60 is further lined by a casing 22, as indicated in FIG. 3. In some embodiments, the casing 22 may be further perforated to allow a fluid to be pumped (referred to herein as “production fluid”) to flow into the casing 22 from the geological formation 30 and pumped to the surface of the wellbore 60.

As further illustrated in FIG. 3, the ESP assembly 10 includes a pump (for example, an electric submersible pump) 300, an electric motor 400 configured to operate the pump 300, and an electric cable 200 configured to power the electric motor 400. In some embodiments, the electric cable 200 comprises a litz wire as described herein. In some embodiments, the motor 400 includes a casing containing an oil-filled space, and at least one motor winding spool of litz wire, as described herein, disposed within the oil-filled space of the casing. The motor winding spools of the assembly 10 may be sufficiently shielded from contaminants of the wellbore so as to avoid operational failure of the assembly 10 during the productive life of the well. The litz wire allows for continuous, improved operation of the motor 400, including at high temperatures.

As noted earlier, the ESP assembly 10 according to some embodiments of the invention is disposed within a wellbore 60 for continuous operation over an extended period of time. Accordingly, in such embodiments, the ESP assembly 10 and the components of the ESP assembly 10 may be subjected to extreme conditions such as high temperatures, high pressures, and exposure to contaminants.

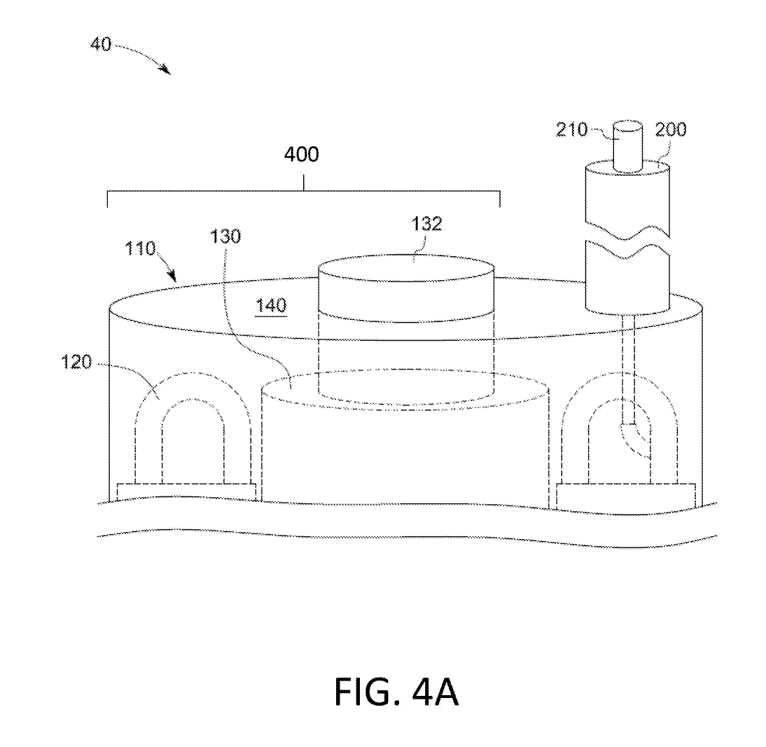

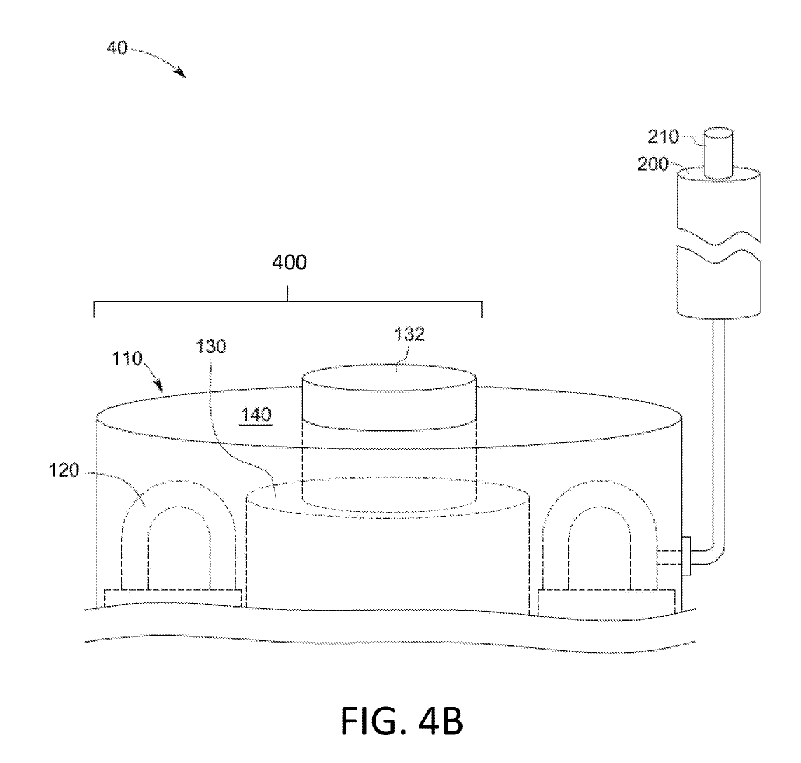

In one embodiment, the present invention provides an electric motor assembly 40, including a motor 400, which is capable of withstanding high temperatures and high pressures, and of being operated at high frequency AC current. In some embodiments, the motor may be operated, for example at a frequency of 60 to 2000 Hz, for example, at a frequency at or above 400 Hz. With reference to FIGS. 4A and 4B, the electric motor assembly 40 includes an electric motor 400 and an electric cable 200 configured to power the electric motor 400. The electric motor 400, according to an embodiment of the invention, includes a housing 110, a stator 120, and a permanent magnetic (PM) rotor 130, wherein the stator 120 and the rotor 130 are disposed within the housing 110. In one embodiment, the housing 110, the stator 120, and the rotor 130 define an internal volume 140 within the housing 110.

Referring to FIG. 4A, in one embodiment, the motor 400 includes an elongated cylindrical housing 110. In one embodiment, the housing 110 is a pressurized vessel. In some embodiments, the motor 400 further includes at least one motor protection system (not shown). In one embodiment, the motor protection system includes one or more bellows, springs, and an oil reservoir.

In one embodiment, the motor 400 further includes a stator 120 disposed within the housing 110. In one embodiment, the stator 120 includes a plurality of metallic laminations disposed within the housing. In one embodiment, to form electrical phases within the stator a plurality of windings are wrapped around the laminations (not shown). The motor 400 may further include a rotatable component or a PM rotor 130. In one embodiment, the rotor 130 includes a drive shaft 132 that extends longitudinally out from the housing 110 and further interconnects to the pump 300, described earlier with reference to FIG. 3. In some embodiments, when the rotor 130 is driven by a turbine of compatible dimension, the motor 400 becomes a generator or an alternator that can generate electricity up to hundreds of kW.

The electric motor assembly 40 further includes at least one electric cable 200 configured to electrically power the electric motor 400. FIG. 4B illustrates an alternate embodiment of the invention, wherein the electric cable 200 is configured to connect to the motor housing 110 from the outside as compared to the configuration illustrated in FIG. 4A. Any other suitable configurations are also within the scope of the invention.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing descriptions, but is only limited by the scope of the appended claims.

This written description uses examples to disclose the invention, including the best mode, and also to enable any person skilled in the art to practice the invention, including making and using devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A litz wire comprising a plurality of twisted strands, wherein one or more of the strands comprises a composite magnet wire comprising:
a metal wire; and
a nanocoating on an outer surface of the metal wire, wherein the nanocoating comprises a polyimide matrix and a plurality of alumina nano particles dispersed homogeneously therein, the alumina nano particles having a phenyl siloxane surface coating;
wherein the litz wire has a temperature index of at least 300° C. as obtained in accordance with ASTM E1641, ASTM E1877, or ASTM D2307.

2. The litz wire of claim 1, wherein the metal wire comprises at least one of copper and a copper alloy.

3. The litz wire of claim 1, wherein the phenyl siloxane surface coating is a product of treatment of the alumina nano particles with at least one of trimethoxyphenylsilane and triethoxyphenylsilane.

4. The litz wire of claim 1, wherein the polyimide matrix comprises at least one of poly(pyromellitic dianhydride-co-4,4′-oxydianiline), amic acid and poly(biphenyltetracarboxylic dianhydride-co-phenylenediamine), amic acid.

5. The litz wire of claim 1, wherein the nanocoating comprises 1% to 6% by weight of the surface treated alumina nano particles.

6. The litz wire of claim 1, wherein the nanocoating has a thickness of 25 μm to 50 μm.

7. The litz wire of claim 1, wherein the alumina nano particles have an average particle size of less than 100 nm.

8. The litz wire of claim 1, wherein the alumina nano particles have an average particle size of 20 nm to 50 nm.

9. The litz wire of claim 1, wherein each of the strands comprises a composite magnet wire as recited in claim 1.

10. The litz wire of claim 1, wherein the plurality of twisted strands is covered with a sheath comprising one or more components selected from polytetrafluoroethylene, polyetheretherketone, glass, and silicone.

11. A motor comprising:
a casing containing an oil-filled space; and
at least one spool of litz wire disposed within the oil-filled space of the casing, the litz wire comprising a plurality of twisted strands, wherein one or more of the strands comprises a composite magnet wire comprising:
a metal wire; and
a nanocoating on an outer surface of the metal wire, wherein the nanocoating comprises a polyimide matrix and a plurality of alumina nano particles dispersed homogeneously therein, the alumina nano particles having a phenyl siloxane surface coating;
wherein the litz wire has a temperature index of at least 300° C. as obtained in accordance with ASTM E1641, ASTM E1877, or ASTM D2307.

12. The motor of claim 11, wherein the metal wire comprises at least one of copper and a copper alloy.

13. The motor of claim 11, wherein the phenyl siloxane surface coating is a product of treatment of the alumina nano particles with at least one of trimethoxyphenylsilane and triethoxyphenylsilane, the polyimide matrix comprises at least one of poly(pyromellitic dianhydride-co-4,4′-oxydianiline), amic acid and poly(biphenyltetracarboxylic dianhydride-co-phenylenediamine), amic acid, and the nanocoating comprises 1% to 6% by weight of the surface treated alumina nano particles.

14. The motor of claim 11, wherein each of the strands of the litz wire comprises a composite magnet wire as recited in claim 11.

15. The motor of claim 11, wherein the plurality of twisted strands is covered with a sheath comprising one or more components selected from polytetrafluoroethylene, polyetheretherketone, glass, and silicone.

16. An electrical submersible pump assembly comprising a pump, a motor configured to operate the pump, and an electrical cable connected to the motor to electrically power the motor, wherein the motor comprises:
a casing containing an oil-filled space; and
at least one spool of litz wire disposed within the oil-filled space of the casing, the litz wire comprising a plurality of twisted strands, wherein one or more of the strands comprises a composite magnet wire comprising:
a metal wire; and
a nanocoating on an outer surface of the metal wire, wherein the nanocoating comprises a polyimide matrix and a plurality of alumina nano particles dispersed homogeneously therein, the alumina nano particles having a phenyl siloxane surface coating;
wherein the litz wire has a temperature index of at least 300° C. as obtained in accordance with ASTM E1641, ASTM E1877, or ASTM D2307.

17. The electrical submersible pump assembly of claim 16, wherein the metal wire comprises at least one of copper and a copper alloy.

18. The electrical submersible pump assembly of claim 16, wherein the phenyl siloxane surface coating is a product of treatment of the alumina nano particles with at least one of trimethoxyphenylsilane and triethoxyphenylsilane, the polyimide matrix comprises at least one of poly(pyromellitic dianhydride-co-4,4′-oxydianiline), amic acid and poly(biphenyltetracarboxylic dianhydride-co-phenylenediamine), amic acid, and the nanocoating comprises 1% to 6% of the surface treated alumina nano particles.

19. The electrical submersible pump assembly of claim 16, wherein each of the strands of the litz wire comprises a composite magnet wire as recited in claim 16.

20. The electrical submersible pump assembly of claim 16, wherein the plurality of twisted strands is covered with a sheath comprising one or more components selected from polytetrafluoroethylene, polyetheretherketone, polyether sulfone, polyphenylsulfone, glass, and silicone.
